(19) United States
(12) Patent Application Publication
(10) Pub. No.: US 2022/0192238 A1
(43) Pub. Date: Jun. 23, 2022

(54) PLANT-BASED DAIRY WHIPPING CREAM ALTERNATIVE AND METHOD TO PREPARE THE SAME

(71) Applicant: WhiteWave Services, Inc., Broomfield, CO (US)

(72) Inventors: Joshua James Smith, Westminster, CO (US); Huaixia Yin, Broomfield, CO (US); Rajay Jayantilal Teraiya, Louisville, CO (US); Gary Jerger, Broomfield, CO (US); Kristina Louise LaFirenza, Churchville, VA (US)

(21) Appl. No.: 17/559,080

(22) Filed: Dec. 22, 2021

Related U.S. Application Data
(60) Provisional application No. 63/128,974, filed on Dec. 22, 2020.

(51) Int. Cl. A23L 9/20; A23L 29/10; A23L 29/238; A23L 29/00

(52) U.S. Cl. CPC A23L 9/24; A23L 29/10; A23V 2002/00; A23L 29/035; A23L 29/238

(57) ABSTRACT

The present disclosure relates to plant-based dairy whipping cream alternative and methods of making the same.

### FIELD OF THE INVENTION

The present disclosure relates to a plant-based dairy whipping cream alternative and a method to prepare the same. More specifically, the present disclosure is directed to whipping cream alternatives that are easily whippable and have good shelf-life.

### TECHNICAL BACKGROUND

There is increased interest in plant-based diets among mainstream consumers who consider themselves vegan, vegetarian or flexitarian. To cater to the dietary needs of such consumers a wide variety of plant-based analogues or alternatives to non-vegan food products are increasingly available. These include plant-based dairy alternatives such as milks, creams, yogurts, cheeses and frozen desserts. The formulation of such products to provide a sensory and/or nutritional equivalent remains challenging.

Although “non-dairy” or “dairy-free” whipping cream alternatives are widely available, such products typically contain either milk derivatives (e.g., casein) or added sugars or sweeteners. Alternatively, plant-based “whipped toppings” are available that typically contain high amounts of sweeteners and added sugars, such as those disclosed in WO 2017/066158.

There remains a need for a plant-based alternative to dairy whipping cream, that contains low amounts of sugars and that is suitable for domestic or at home use (i.e., easily whippable).

### SUMMARY OF THE INVENTION

In some embodiments, the present disclosure follows from the unexpected finding that a plant-based dairy whipping cream alternative having good whippability, shelf-life and organoleptic characteristics can be prepared by using a low HLB emulsifier together with plant proteins. Accordingly, in a first aspect, the present disclosure provides a plant-based dairy whipping cream alternative. In a second aspect, the present disclosure provides a method of making the same.

### DETAILED DESCRIPTION OF THE INVENTION

As used herein, the term “ppm” shall be taken to mean “parts per million”. One mililitre in 1 liter is 1000 ppm and one thousandth of a mililitre (0.001 g) in 1 liter is one ppm.

As used herein, the term “x % (w/w)” “x % w/w” is equivalent to “x g per 100 g”. Unless indicated otherwise, all % value shall be taken to indicate x % w/w.

As used herein, the term “x % (v/v)” “x % v/v” is equivalent to “x ml per 100 ml”.

In the context of this application, the term “at least” also includes the starting point of the open range. For example, an amount of “at least 95.00% w/w” means any amount equal to 95.00 percentage by weight or above.

In the context of this application, the term “about” defines a range of plus or minus 10% of the cited value. For example, an amount of “about 20 weight %” means any amount within the range of 18.00 to 22.00 weight %.

As used herein, the terms “vegan”, “plant-based” or “plant based” shall be taken to mean a composition or product which comprises plant or plant-derived matter but which does not comprise animal or animal-derived matter, including but not limited to dairy, egg, fish, shellfish, meat, dairy milk and insects.

As used herein, the term “dairy” shall be taken to mean a composition or product comprises or consists of mammalian milk matter, i.e., the lacteal secretion obtainable by milking.

As used herein, the terms “-free” or “free from” shall be taken to mean that a given substance is not added to make a composition or product but, unless specified, where trace amounts or contaminants thereof may be present.

As used herein, the term “added sugar” shall refer to sugars that are added during the production or processing of foods (e.g., refined sugars that may be added to a vegetal base of processed plant matter) as opposed to sugars naturally occurring in said foods. Added sugars include sugars (free, mono- and disaccharides), sugars from syrups (e.g., rice or cereal syrups) and honey, and sugars from concentrated fruit or vegetable juices that are in excess of what would be expected from the same volume of 100 percent fruit or vegetable juice of the same type.

As used herein, the terms plant-based “alternative”, “analogue” or “substitute” shall be taken to mean a plant-based food or beverage composition that is formulated to simulate the organoleptic and/or functional qualities of a non-plant-based product. Accordingly, “plant-based dairy whipping cream alternative” shall be taken to mean a plant-based composition formulated to mimic the organoleptic and/or functional qualities of dairy whipping cream including but not limited to visual aspects and the whippability.

As used herein, the term “whippability” shall refer to the ability of an emulsion or partial emulsion to form a foam upon incorporation of air.

As used herein, the term “lecithin” shall be taken to mean mixtures or fractions of phosphatides obtained by physical procedures from animal or vegetable foodstuffs and suitable for use as food additive E322.

As used herein, the term “guar gum” shall be taken to mean a polysaccharide extracted from guar beans that has thickening and stabilizing properties and is suitable for use as food additive E412.

As used herein, the term “HLB” shall be taken to mean the hydrophilic-lipophilic balance as determined by calculating hydrophilic or lipophilic values of the different regions of the molecule. Suitable methods for performing such calculations are known in the art such as the Griffin 1954 “Calculation of HLB Values of Non-Ionic Surfactants”, Journal of the Society of Cosmetic Chemists, 5 (4): 249-56.

As used herein, the term “overrun” shall be taken to mean the air incorporated into an aerated food product, such as a whipped cream or ice cream.

As used herein, the term “% overrun” shall be taken to refer to the volume of air in an aerated food product relative to the volume of liquid or solid.

As used herein, the term “total solids” shall be taken to mean the total content dry matter in a given composition and may be expressed as % w/w of the composition.

As used herein, the expression “hydrolyzed proteins” refers to proteins which have been hydrolyzed into their amino acids and peptides components. The hydrolysis of the proteins may be carried out by any method well known to the person skilled in the art. By way of example, the hydrolysis can be accomplished by a chemical process, e.g., by adding the protein in an acid-based solution or using various enzymes such as proteases.

In a first aspect, the present disclosure provides a plant-based dairy whipping cream alternative, and in a second aspect, the present disclosure provides a method of making the same.

### First Aspect

In a first aspect, the present disclosure provides a plant-based dairy whipping cream alternative.

In one embodiment the present disclosure provides a plant-based dairy whipping cream alternative comprising non-soy pulse protein and an emulsifying agent which is HLB 6 or below.

In one embodiment the present disclosure provides a plant-based dairy whipping cream alternative comprising 0.1%-15% w/w non-soy pulse protein and up to 5% of an emulsifying agent which is HLB 6 or below.

In one embodiment the present disclosure provides a plant-based dairy whipping cream alternative comprising:

i) 45-10% w/w saturated triglyceride oil;

ii) 0-10% w/w unsaturated triglyceride oil;

iii) 0.1%-15% w/w non-soy pulse protein;

iv) 0-5% w/w emulsifying agent which is HLB 6 or below; and

v) 0-5% w/w guar gum.

In some embodiments, the plant-based dairy whipping cream alternative is an emulsion. In some embodiments, the emulsion is an oil-in-water emulsion.

In some embodiments, the plant-based dairy whipping cream alternative comprises water in an amount of 20%-79.9% w/w. In some embodiments, the plant-based dairy whipping cream alternative comprises water in an amount of 30% to 75% w/w. In some embodiments, the plant-based dairy whipping cream alternative comprises water in an amount of 40% to 70% w/w.

In some embodiments, the plant-based dairy whipping cream alternative comprises saturated triglyceride oil in an amount of 45-10% w/w. In some embodiments, the plant-based dairy whipping cream alternative comprises saturated triglyceride oil in an amount of 40%-10% w/w. In some embodiments, the plant-based dairy whipping cream alternative comprises saturated triglyceride oil in an amount of 30%-12% w/w. In some embodiments, the plant-based dairy whipping cream alternative comprises saturated triglyceride oil in an amount of 30-15% w/w. In some embodiments, saturated triglyceride oil may be any oil suitable for human consumption derived from plant material comprising at least 70%, 80%, 85%, 90% w/w or more saturated fats of total fat content. In some embodiments, the preferred saturated oils are coconut oil and palm kernel oil, palm oil and/or combinations or mixtures thereof. In some embodiments, the preferred saturated oil is coconut oil.

In some embodiments, the plant-based dairy whipping cream alternative comprises unsaturated triglyceride oil in an amount of 0-10% w/w. In some embodiments, the plant-based dairy whipping cream alternative comprises unsaturated triglyceride oil in an amount of 0.01-10% w/w. In some embodiments, the plant-based dairy whipping cream alternative comprises unsaturated triglyceride oil in an amount of 10%-2% w/w. In some embodiments, the plant-based dairy whipping cream alternative comprises unsaturated triglyceride oil in an amount of 8%-3% w/w. In some embodiments, unsaturated triglyceride oil may be any oil suitable for human consumption derived from plant material comprising less than 25%, 20%, 15% w/w or less saturated fats of total fat content. In some embodiments, the unsaturated triglyceride oil is a neutral tasting oil. In some embodiments, the unsaturated triglyceride oil is sunflower oil.

In some embodiments, the plant-based dairy whipping cream alternative comprises non-soy pulse protein in an amount of 0.1%-15% w/w. In some embodiments, the plant-based dairy whipping cream alternative comprises non-soy pulse protein in an amount of up to 3, 4, 5, 6, 7, 8, 9 or 10% w/w. In some embodiments, the plant-based dairy whipping cream alternative comprises non-soy pulse protein in an amount of 0.1% w/w to 3% w/w or 0.1% w/w to 1.5% w/w. In some embodiments, the plant-based dairy whipping cream alternative comprises non-soy pulse protein in an amount of 0.5% w/w to 1.2%. In some embodiments, non-soy pulse proteins may be provided in the form of any protein ingredient derived from plant material such as a protein isolate or concentrate as determined by their % w/w protein.

In some embodiments, the protein concentrate may comprise up to about 60%, 70% or more total protein on a dry matter basis e.g., 50% up to 70% w/w. Preferably, the rest of the dry matter of the vegetal protein concentrate comprises carbohydrates such as starch and fibers. A protein concentrate may comprise a single type of protein or a combination of different types of proteins. A protein concentrate may comprise a protein from a single vegetal variety or a combination of different vegetal varieties.

In some embodiments, the protein isolate may comprise greater than or equal to about 70%, 75%, 80%, 85% 90% w/w, or more total protein on a dry matter basis, e.g., 70% to 95% w/w.

In some embodiments, the protein ingredient may comprise a single type of protein or a combination of different types of proteins. In some embodiments, the protein ingredient may comprise a protein from a single vegetal variety or a combination of different vegetal varieties. In some embodiments, the protein ingredient may have been partially or fully hydrolyzed. In some embodiments, the protein ingredient has been treated to reduce or remove off-notes such as bitterness.

In some embodiments, the protein ingredient may comprise up to about 40%, 35%, 30%, 25%, 20%, 15%, 10%, 5% or less total carbohydrates on a dry matter basis, e.g., 5% up to 40% w/w carbohydrate.

In some embodiments, the protein ingredient may be in powdered, spray dried, suspension, slurry or liquid form. Particularly preferred is a powdered or spray-dried form. In some embodiments, non-soy pulse proteins may be any such proteins having foaming properties. In some embodiments, non-soy pulse proteins are obtained from pea, chickpea, fava bean, mung and/or combinations or mixtures thereof. In some embodiments, non-soy pulse proteins are fava proteins.

In some embodiments, the plant-based dairy whipping cream alternative comprises an emulsifying agent which is HLB 6 or below in an amount of 0%-5% w/w. In some embodiments, the plant-based dairy whipping cream alternative comprises an emulsifying agent which is HLB 6 or below in an amount of up to 2, 3, or 4%. In some embodiments, the plant-based dairy whipping cream alternative comprises an emulsifying agent which is HLB 6 or below in an amount of 0-1% w/w. In some embodiments, the plant-based dairy whipping cream alternative comprises an emulsifying agent which is HLB 6 or below in an amount of 0.01-1% w/w. In some embodiments, the plant-based dairy whipping cream alternative comprises an emulsifying agent which is HLB 6 or below in an amount of 0.01-0.5% w/w. In some embodiments, emulsifying agents may be any emulsifying agent suitable for human consumption derived from plant material. In some embodiments, the emulsifying agents are lecithins obtained from soy, rapeseed, maize, sunflowers and peanuts and/or combinations or mixtures thereof. In some embodiments, the emulsifiers are non-soy lecithin, preferably sunflower lecithin. To achieve good whippability and stability over shelf-life the inventors determined that the use of a low HLB emulsifier was preferred. Accordingly, in embodiments, an emulsifier having a HLB value of 6 or below is preferred. In some embodiments, an emulsifier having a HLB value of 3-6 is preferred. In some embodiments an emulsifier having a HLB value of 3-5 is preferred. In some embodiments, the plant-based dairy whipping cream alternative comprises an emulsifying agent which is sunflower lecithin having a HLB value of 3-6.

In some embodiments, the plant-based dairy whipping cream alternative comprises guar gum in an amount of 0%-5% w/w. In some embodiments, the plant-based dairy whipping cream alternative comprises 0-1% w/w In some embodiments, the plant-based dairy whipping cream alternative comprises 0.01-1% w/w. In some embodiments, the plant-based dairy whipping cream alternative comprises 0.001-0.5% w/w.

In some embodiments, the plant-based dairy whipping cream alternative may optionally comprise a flavouring agent in an amount of 0%-5% w/w. In some embodiments, the plant-based dairy whipping cream alternative may optionally comprise a flavouring agent in an amount of 0-2% w/w. In some embodiments, the plant-based dairy whipping cream alternative may optionally comprise a flavouring agent in an amount of 0.001-2% w/w. In some embodiments, the plant-based dairy whipping cream alternative may optionally comprise a flavouring agent in an amount of 0.01-0.5% w/w. In some embodiments, the plant-based dairy whipping cream alternative may optionally comprise a flavouring agent in an amount of 0.2-0.4% w/w. Flavouring agents may be any flavouring agents suitable for human consumption derived from plant material. In some embodiments, the flavouring agents are dairy-alternative flavouring agents such as plant-based analogue milk, butter, cream, mascarpone flavours and/or flavouring agents for masking of unwanted off-notes.

In some embodiments, the plant-based dairy whipping cream alternative comprises up to 55%, 50%, 45%, 40%, 35%, 30%, 25%, 20%, 15% or 10% by weight total fat. In some embodiments, the plant-based dairy whipping cream alternative comprises 45-10% w/w total fat. In some embodiments, the plant-based dairy whipping cream alternative comprises 40%-10% w/w total fat. In some embodiments, the plant-based dairy whipping cream alternative comprises 30%-12% w/w total fat. In some embodiments, the plant-based dairy whipping cream alternative comprises 30-15% w/w total fat.

In some embodiments, the plant-based dairy whipping cream alternative comprises up to 1, 1.5, 2, 3, 4, 5, 6, 7, 8, 9, 10 or 15% by weight total protein. In some embodiments, the plant-based dairy whipping cream alternative comprises 0.1%45% w/w by weight total protein. In some embodiments, the plant-based dairy whipping cream alternative comprises 0.1% w/w to 1.5% w/w by weight total protein. In some embodiments, the plant-based dairy whipping cream alternative comprises 0.5% w/w to 1.2%. % by weight total protein.

In some embodiments, the plant-based dairy whipping cream alternative comprises up to 0.01, 0.1, 0.2, 0.3, 0.4, 0.5, 0.6, 0.7, 0.8, 0.9, 1, 1.5, 2, 2.5, 3, 3.5, 4, 4.5 or 5% by weight total carbohydrate. In some embodiments, the plant-based dairy whipping cream alternative comprises 0% w/w to 5% w/w, 0% w/w to 2% w/w, 0.01% w/w to 2% w/w, 0% w/w to 1% w/w, 0.01% w/w to 1% w/w by weight total carbohydrates.

In some embodiments, the plant-based dairy whipping cream alternative is free-from added sugars beyond those naturally occurring in the oils i) and ii), non-soy pulse protein iii), emulsifying agent iv), guar gum v) and flavouring agents.

In some embodiments, the plant-based dairy whipping cream alternative is free-from non-nutritive sweetening agents beyond those naturally occurring in the oils i) and ii), non-soy pulse protein iii), emulsifying agent iv), guar gum v) and flavouring agents.

In some embodiments, the plant-based dairy whipping cream alternative is free-from modified starches, hydrocolloids, stabilizing agents, whitening agents, thickening agents and emulsifying agents beyond those that may be present in the non-soy pulse protein ingredient iii), emulsifying agent iv) and guar gum v).

In some embodiments, the plant-based dairy whipping cream alternative is free-from cereals or cereals-derived matter, such as wheat.

In some embodiments, the plant-based dairy whipping cream alternative is free-from and does not comprise animal matter, such as dairy, egg, fish, shellfish, meat, insect and/or derivatives thereof. In some embodiments, the plant-based dairy whipping cream alternative is free-from and does not comprise dairy derived matter such as whey, casein and caseinate.

In some embodiments, the plant-based dairy whipping cream alternative is free-from soy or soy-derived matter.

In some embodiments, the plant-based dairy whipping cream alternative is free-from peanut or peanut-derived matter.

In some embodiments, the plant-based dairy whipping cream alternative is free-from tree nut or tree nut-derived matter.

In some embodiments, the plant-based dairy whipping cream alternative is a pourable liquid at 1° C. to 10° C.

In some embodiments, the plant-based dairy whipping cream alternative has a total solids content of 10-40% w/w, preferably 20%-40% w/w, more preferably 25% to 35% w/w, most preferably 30% to 35% w/w.

In some embodiments, the plant-based dairy whipping cream alternative has a particle size distribution having at least 80%, 85%, 90%, 95% or more particles having a maximum dimension equal to or less than 50 μm, 40 μm, 30 μm or 25 μm.

In some embodiments, the plant-based dairy whipping cream alternative has a pH of 6.0-8.5, preferably 6.5-8.0, more preferably 7-7.5.

In some embodiments, the plant-based dairy whipping cream alternative has a viscosity lower than 300 mPa·s, more preferably lower than 250 mPa·s and most preferably lower than 200 mPa·s, at 10° C. In some embodiments, the plant-based dairy whipping cream alternative has a viscosity range of 1 to 300 mPa·s, 1 to 200 mPa·s at 10° C. In some embodiments, the plant-based dairy whipping cream alternative has a viscosity range of 10 to 300 mPa·s, 50 to 250 mPa·s, or 50 to 200 mPa·s, at 10° C.

In some embodiments, the plant-based dairy whipping cream alternative can be aerated by means of a device such as standard domestic hand-held or stand mixer, e.g., Cuisinart stand mixer, or by hand using a device such as paddle, fork to whisk to provide an aerated foam whipped product. In some embodiments, the product may be whipped at a temperature of 1° C. to 10° C. to achieve an overrun of up to at least about 150%, 140%, 130%, 120%, 110%, 100%, 90%, 80% without splitting or curdling.

In some embodiments, the plant-based dairy whipping cream alternative is a packaged product. In some embodiments, the plant-based dairy whipping cream alternative is packaged into a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g or 500 g or about 1 oz, 2 oz, 3 oz, 4 oz, 5 oz, 6 oz or 12 oz product by weight. In some embodiments, the container can be any suitable beverage container, such as a cup, a can, a bottle, a carton or “tetrapak” type packaging, or a flexible container such as a pouch. In some embodiments, the container is the packaging of the plant-based dairy whipping cream alternative. In some embodiments, the container typically presents an opening and a body. In some embodiments, the opening can be sealed by sealing means such as a cap, a flexible lid or a rigid lid. In some embodiments, the opening and/or sealing means is a tearable or detachable part of the container. In some embodiments, the container can be made of a material, optionally layered, comprising plastics, preferably recyclable and/or recycled, paper and/or metal, or glass.

In some embodiments, the plant-based dairy whipping cream alternative is a packaged product that can be stored, transported and/or distributed at a temperature of from 1° C. to 10° C., preferably 1° C. to 5° C. for at least about 30 days, at least about 70 days or at least about 90 days from packaging. In some embodiments, the plant-based dairy whipping cream alternative is a packaged product that can be stored, transported and/or distributed at a temperature of from 1° C. to 10° C. for at least about 30 days, at least about 70 days or at least about 90 days from packaging without a significant amount of physical separation such as splitting, curdling, clumping, aggregation or sedimentation.

In some embodiments, the disclosure relates to a plant-based dairy whipping cream alternative comprising:

i) 45-10% w/w coconut oil;

ii) 0.01-10% w/w sunflower oil;

iii) 0.1%-15% w/w fava bean protein;

iv) 0-5% w/w sunflower lecithin HLB 3-6;

v) 0-1% w/w guar gum; and

vi) 0-2% w/w flavouring agents.

In some embodiments, the product further comprises water to provide a total solids content of 20%-40% w/w, and has a pH of 7-7.5.

In a further embodiment, the disclosure relates to a plant-based dairy whipping cream alternative comprising:

i) 40-10% w/w coconut oil;

ii) 2-10% w/w sunflower oil;

iii) 0.1%-1.5% w/w fava bean protein;

iv) 0-1% w/w sunflower lecithin HLB 3-6;

v) 0.01-1% w/w guar gum; and

vi) 0-2% w/w flavouring agents.

In some embodiments, the product preferably further comprises water to provide a total solids content of 20%-40% w/w, and has a pH of 7-7.5.

In a further embodiment, the disclosure relates to a plant-based dairy whipping cream alternative comprising:

i) 30-12% w/w coconut oil;

ii) 2-10% w/w sunflower oil;

iii) 0.1%4.2% w/w fava bean protein;

iv) 0-1% w/w sunflower lecithin HLB 3-6;

v) 0.01-1% w/w guar gum; and

vi) 0-2% w/w flavouring agents.

In some embodiments, the product preferably further comprise water and to provide a total solids content of 20%-40% w/w, and has a pH of 7-7.5.

In a further embodiment, the disclosure relates to a plant-based dairy whipping cream alternative comprising:

i) 30-12% w/w coconut oil;

ii) 2-10% w/w sunflower oil;

iii) 0.1%4.2% w/w fava bean protein; iv) 0 .01-1% w/w sunflower lecithin HLB 3-6;

v) 0.01-1% w/w guar gum; and

vi) 0-2% w/w flavouring agents.

In some embodiments, the product preferably further comprises water to provide a total solids content of 20%-40%, and has a pH of 7-7.5.

### Second Aspect

In a second aspect, the present disclosure provides a method of making the plant-based dairy whipping cream alternative.

In one embodiment the method comprises i) providing an aqueous solution comprising oils, protein, emulsifier, guar gum and optionally flavouring agents; ii) emulsifying the mixture to provide a plant-based dairy whipping cream alternative; iii) packaging the plant-based dairy whipping cream alternative and wherein the oils, protein, emulsifier, guar gum and flavouring agents, are present in amounts to obtain a dairy whipping cream alternative comprising:

i) 45-10% w/w saturated triglyceride oil;

ii) 0-10% w/w unsaturated triglyceride oil;

iii) 0.1%-15% w/w non-soy pulse protein;

iv) 0-5% w/w emulsifying agent which is HLB 6 or below; and

v) 0-5% w/w guar gum.

In some embodiments, the oils, protein, emulsifier, guar gum and optionally flavouring agents and any other ingredients are added in amounts to obtain a plant-based dairy whipping cream alternative with the desired composition, as described in the present specification.

In step i) of the method, an aqueous solution comprising oils, protein, emulsifier, guar gum and optionally flavouring agents is prepared. This may be performed in any suitable manners, and means of preparing such aqueous solution for the purpose of preparing emulsions are well known in the art.

In some embodiments, the guar gum and protein ingredients are dispersed in an aqueous liquid, preferably water, and allowed to hydrate and dissolve. To facilitate hydration and dissolution, the dispersion may be aided by mechanical means using suitable mixing devices. Other water-soluble ingredients, may be added to the aqueous solution at this stage. The oils are then mixed or combined into the aqueous solution, the mixing may be aided by mechanical means using suitable mixing devices and the emulsifier (preferably lecithin) may be mixed either prior to, concurrently with, or subsequent to the addition of the oils. The flavouring agents may be mixed either prior to, concurrently with, or subsequent to the addition of the oils.

In some embodiments, a portion (in embodiments 5%-10% w/w) of the aqueous liquid is reserved until the oils, protein, emulsifier, guar gum and optionally flavouring agents are combined. In some embodiments, the total solids content of the aqueous solution is determined and is adjusted to of 10-40% w/w, preferably 20%-40% w/w, more preferably 25% to 35% w/w, most preferably 30% to 35% w/w by the addition of the reserved aqueous liquid.

In step ii) of the method, the oils are emulsified in the aqueous solution prepared in step i) to provide a plant-based dairy whipping cream alternative. Methods for the emulsification of oil in water preparations are known in the art and preferably carried out by means of mixing and/or homogenization. In some embodiments, it is particularly preferred that the emulsification is carried out by means of homogenization and that the homogenization pressure is adjusted to provide a plant-based dairy whipping cream alternative having a particle size distribution having at least 80%, 85%, 90%, 95% or more particles having a maximum dimension equal to or less than 50 μm, 40 μm, 30 μm or 25 μm after emulsification. In some embodiments, an adjustment of the homogenization pressure to provide a plant-based dairy whipping cream alternative having a particle size distribution having at least 95% or more particles having a maximum dimension equal to or less than 25 μm after emulsification.

In some embodiments, the composition is heat treated to ensure that the product remains aseptic until consumption. In some embodiments, the heat treatment is at least equivalent to pasteurization and may be carried out prior to, concurrently with, or subsequent to the emulsification of step ii.

In step iii) of the method, the plant-based dairy whipping cream alternative is packaged into a suitable container. In some embodiments, the plant-based dairy whipping cream alternative is packaged into a sealed or sealable container containing about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g, 320 g or 500 g or about 1 oz, 2 oz, 3 oz, 4 oz, 5 oz, 6 oz or 12 oz product by weight. It is particularly preferred that the packaging is carried out by aseptic means. In some embodiments, the container can be any suitable beverage container, such as a cup, a can, a bottle, a carton or “tetrapak” type packaging, or a flexible container such as a pouch. In some embodiments, the container is the packaging of the plant-based dairy whipping cream alternative. In some embodiments, the container typically presents an opening and a body. In some embodiments, the opening can be sealed by sealing means such as a cap, a flexible lid or a rigid lid. In some embodiments, the opening and/or sealing means is a tearable or detachable part of the container. In some embodiments, the container can be made of a material, optionally layered, comprising plastics, preferably recyclable and/or recycled, paper and/or metal, or glass.

In some embodiments of the method, in step i), an aqueous solution comprising 45-10% w/w coconut oil, 0.01-10% w/w sunflower oil, 0.1%-15% w/w fava bean protein, 0-5% w/w sunflower lecithin HLB 3-6, 0-5% w/w guar gum, 0-2% w/w flavouring agents is prepared according to the herein described methods. In some embodiments, the total solids content of the aqueous solution is determined and is adjusted to 10-40%, preferably 20%-40%, more preferably 25% to 35% w/w, most preferably 30% to 35% w/w. In some embodiments, in step ii) of the method, the oils are emulsified in the aqueous solution prepared in step i) to provide a plant-based dairy whipping cream alternative. In some embodiments, in step iii) of the method, the plant-based dairy whipping cream alternative is packaged into a suitable container.

In some embodiments of the method, in step i), an aqueous solution comprising 40-10% w/w coconut oil, 2-10% w/w sunflower oil, 0.1%-1.5% w/w fava bean protein, 0-1% w/w sunflower lecithin HLB 3-6, 0.01-1% w/w guar gum, 0-2% w/w flavouring agents is prepared according to the herein described methods. In some embodiments, the total solids content of the aqueous solution is determined and is adjusted to 10-40%, preferably 20%-40%, more preferably 25% to 35% w/w, most preferably 30% to 35% w/w. In some embodiments, in step ii) of the method the oils are emulsified in the aqueous solution prepared in step i) to provide a plant-based dairy whipping cream alternative. In some embodiments, in step iii) of the method the plant-based dairy whipping cream alternative is packaged into a suitable container.

In some embodiments of the method, in step i), an aqueous solution comprising 30-12% w/w coconut oil, 2-10% w/w sunflower oil, 0.1%-1.2% w/w fava bean protein, 0-1% w/w sunflower lecithin HLB 3-6, 0.01-1% w/w guar gum, 0-2% w/w flavouring agents is prepared according to the herein described methods. In some embodiments, the total solids content of the aqueous solution is determined and is adjusted to 10-40% w/w, preferably 20%-40% w/w, more preferably 25% to 35% w/w, most preferably 30% to 35% w/w. In some embodiments, in step ii) of the method, the oils are emulsified in the aqueous solution prepared in step i) to provide a plant-based dairy whipping cream alternative. In some embodiments, in step iii) of the method, the plant-based dairy whipping cream alternative is packaged into a suitable container.

In some embodiments of the method, in step i), an aqueous solution comprising 30-12% w/w coconut oil, 2-10% w/w sunflower oil, 0.1%-1.2% w/w fava bean protein, 0.01-1% w/w sunflower lecithin HLB 3-6, 0.01-1% w/w guar gum, 0-2% w/w flavouring agents is prepared according to the herein described methods. In some embodiments, the total solids content of the aqueous solution is determined and is adjusted to 10-40%, preferably 20%-40%, more preferably 25% to 35% w/w, most preferably 30% to 35% w/w. In some embodiments, in step ii) of the method the oils are emulsified in the aqueous solution prepared in step i) to provide a plant-based dairy whipping cream alternative. In some embodiments, in step iii) of the method the plant-based dairy whipping cream alternative is packaged into a suitable container.

The disclosure will be further illustrated by the following non-limiting Examples.

### EXAMPLES

The following Examples relate to the formulation of a plant-based whipping cream alternative having good whippability and stability during a refrigerated shelf-life of 2 months.

### Example 1

Liquid plant-based whipping cream alternative were prepared as below.

A liquid mix was prepared by mixing together the ingredients as listed in Table 1.

The water was mixed under continuous agitation with the guar gum and fava bean protein ingredient in a tank until dispersed, the coconut and sunflower oils were then added to the tank and mixed until combined. The sunflower lecithin was added with the fat components (subsequent testing confirmed it may also be mixed in after addition of the fats) and finally the flavouring agent was added to the tank and mixed. Additional water was added if necessary, to achieve the target total solids content. The liquid mix was homogenized and aseptically filled into cartons.

Total solids content of the finished product is in the target range of 30% to 36% w/w, pH 7-7.5, shelf-life up to 70 days under refrigerated conditions.

The physicochemical stability and sensory characteristics of the whipping cream substitute were judged by trained panellists. No phase separation or significant viscosity changes were observed at the end of storage. It was surprisingly found that the whipping cream substitute had a good appearance, mouth-feel, smooth texture and a good flavour. The whipping capacity of the whipping cream substitute was tested by whipping the chilled product using a domestic stand mixer at high speed and compared to that of a dairy whipping cream. Surprisingly, the plant-based alternative achieved 100% overrun in a faster time than standard dairy whipping cream.

One formulation was tested replacing all of the sunflower oil (10% w/w) with coconut oil, and although the formula whipped well, processability was improved by the addition of sunflower oil. Alternative formulations were tested having a sunflower oil content of 6% and 10% (replacing coconut oil) and the formula whipped well.

TABLE 1

| Ingredient | % weight |
|---|---|
| Water | 65.67 |
| Coconut oil | 33-23% |
| Sunflower oil | 0-10% |
| Fava bean protein concentrate ingredient | 1 |
| (60% protein) | |
| Guar gum | 0.18 |
| Flavouring agent | 0.15 |
| Sunflower lecithin | 0.10 |

### Example 2: Fava Protein Content

Liquid plant-based whipping cream alternatives were prepared as in Example 1, but the amounts and types of fava protein ingredients were varied. A fava protein concentrate containing 60% protein was tested at 1% and 2% w/w concentrations. At 1% w/w the product was found to have a good texture and to be whippable using a stand mixer. At 2% w/w protein concentrate the product was found to be thick and not whippable, this was confirmed at 3% w/w protein concentrate (see Table 1). These findings (maximum fava protein content in product) were confirmed using a fava bean protein isolate having 90% w/w fava bean protein. At 1% the product had a good texture and was whippable, however at 3% it was not. Ranges between 1% and 3% were confirmed as having good texture and whippability.

Thus, it was concluded that the fava bean protein content of the product was ideally less than 1.2% w/w, preferably 0.1%-1% w/w when using a protein isolate or concentrate ingredient having a protein content of 50% to 99%, e.g., 60% to 90%. Typically, the remaining bulk of such plant protein concentrates or isolates constitutes plant starches or fibers.

TABLE 1

| Protein concentrate w/w | Results | Whipping time |
|---|---|---|
| 1% | Control, whipped well | 90 sec |
| 2% | very thick and not acceptable | Not applicable |
| 3% | thickened up right away | Not applicable |

### Example 3: Emulsifier HLB

Liquid plant-based whipping cream alternatives were prepared as in Example 1, but the types of lecithin emulsifiers were varied. Using a HLB 8 emulsifier at 2% w/w, the emulsion was thin, stable but not whippable. Using a HLB 7 emulsifier, the texture was acceptable but the product took an extremely long time to be whipped (277 seconds).

HLB 3 emulsifier was tested at 0.1% and 2% w/w and provided emulsions that were whippable in 2 minutes or less. It was concluded that the emulsifiers were optional but preferred and that the use of an emulsifier having a HLB of less than 8, preferably 3-6 at up to 2% w/w was preferred.

### Example 4: Coconut Oil Content

Liquid plant-based whipping cream alternative were prepared as in Example 1, but the amounts and coconut oil were varied as provided in Table 2. It was concluded that coconut oil in the range of 30% to 12% w/w would be acceptable, preferably 15% to 30% w/w.

TABLE 2

| Coconut oil content | Test results | Whipping time |
|---|---|---|
| 26% | Control, whipped well | 90 sec |
| 23% | Whipped well | 120 sec |
| 15% | Whipped well | 120 sec |
| 11% | Didn't whip | NA |

What is claimed is:

1. A plant-based dairy whipping cream alternative comprising non-soy pulse protein and an emulsifying agent which is HLB 6 or below.

2. A plant-based dairy whipping cream alternative comprising 0.1%-15% w/w non-soy pulse protein and up to 5% of an emulsifying agent which is HLB 6 or below.

3. A plant-based dairy whipping cream alternative comprising:
45 to 10% w/w saturated triglyceride oil;
0 to 10% w/w unsaturated triglyceride oil;
0.1 to 15% w/w non-soy pulse protein;
0 to 5% w/w emulsifying agent which is HLB 6 or below; and
0 to 5% w/w guar gum.

4. The plant-based dairy whipping cream alternative according to claim 3, wherein the plant-based dairy whipping cream alternative is free-from added sugars.

5. The plant-based dairy whipping cream alternative according to claim 4, wherein the saturated triglyceride oil is selected from coconut oil, palm oil and/or combinations thereof.

6. The plant-based dairy whipping cream alternative according to claim 3 comprising 40% to 10% w/w saturated triglyceride oil.

7. The plant-based dairy whipping cream alternative according to claim 3, wherein the unsaturated triglyceride oil is sunflower oil.

8. The plant-based dairy whipping cream alternative according to claim 3 comprising 10% to 2% w/w unsaturated triglyceride oil.

9. The plant-based dairy whipping cream alternative according to claim 3, wherein the non-soy pulse protein is selected from the group consisting of pea, chickpea, fava bean, mung and/or combinations or mixtures thereof.

10. The plant-based dairy whipping cream alternative according to claim 3 comprising 0.1% to 1% w/w non-soy pulse protein.

11. The plant-based dairy whipping cream alternative according to claim 3 characterized in that the emulsifying agent is lecithin.

12. The plant-based dairy whipping cream alternative according to claim 1 that may be whipped to at least 80% overrun.

13. The plant-based dairy whipping cream alternative according to claim 3, wherein the plant-based dairy whipping cream alternative has a total solids content of 10 to 40% w/w.

14. The plant-based dairy whipping cream alternative according to claim 1, wherein the plant-based dairy whipping cream alternative has a particle size distribution having at least 80%, 85%, 90%, 95% or more particles having a maximum dimension equal to or less than 50 μm.

15. A plant-based dairy whipping cream alternative comprising:
20 to 25% w/w coconut oil;
5 to 10% w/w sunflower oil;
0.6 to 1.2% w/w fava bean protein;
0.01 to 0.2% w/w sunflower lecithin HLB 3-6;
0.1 to 0.25% w/w guar gum; and
0.2 to 0.4% w/w flavouring agents.

16. A plant-based dairy whipping cream alternative comprising:
25 to 35% w/w coconut oil;
0.6 to 1.2% w/w fava bean protein;
0.01 to 0.2% w/w sunflower lecithin HLB 3-6;
0.1 to 0.25% w/w guar gum; and
0.2 to 0.4% w/w flavouring agents.

17. A method for preparing a plant-based dairy whipping cream alternative comprising:
i) providing an aqueous mixture comprising:
45 to 10% w/w saturated triglyceride oil;
0 to 10% w/w unsaturated triglyceride oil;
0.1 to 15% w/w non-soy pulse protein;
0 to 5% w/w emulsifying agent which is HLB 6 or below;
0 to 5% w/w guar gum;
ii) emulsifying the aqueous mixture to provide plant-based dairy whipping cream alternative; and
iii) packaging the plant-based dairy whipping cream alternative.

18. The method according to claim 17, wherein the emulsification is carried out by means of homogenization.

19. The method according to claim 18, wherein the homogenization pressure is adjusted to provide a plant-based dairy whipping cream alternative having a particle size distribution having at least 80% or more particles having a maximum dimension equal to or less than 50 μm.
